(19) United States
(12) Patent Application Publication
(10) Pub. No.: US 2026/0042465 A1
(43) Pub. Date: Feb. 12, 2026

(54) METHOD AND CONTROL SYSTEM FOR OPERATING A SELF-DRIVING VEHICLE

(71) Applicant: ZF CV Systems Global GmbH, Bern (CH)

(72) Inventors: Michael Tappeiner, Friedrichshafen (DE); Florian Keller, Mindersdorf (Hohenfels) (DE)

(21) Appl. No.: 19/291,628

(22) Filed: Aug. 6, 2025

(30) Foreign Application Priority Data
Aug. 6, 2024 (DE) 10 2024 122 345.6

(51) Int. Cl. B60W 60/00; B60W 10/18; B60W 10/20

(52) U.S. Cl. CPC B60W 60/0015; B60W 10/18; B60W 10/20; B60W 2540/18

(57) ABSTRACT

A method for operating a self-driving vehicle is provided. The method includes specifying a lateral dynamics requirement for controlling the lateral dynamics of the self-driving vehicle along a route. The lateral dynamics requirement is communicated to a steering control device for controlling steering kinematics of the self-driving vehicle. The method checks whether the communicated lateral dynamics requirement satisfies a lateral dynamics criterion for the operation of the self-driving vehicle, and communicates a brake command to stop the self-driving vehicle depending on a checking result resulting from the checking step.

### CROSS REFERENCE TO RELATED APPLICATIONS

This application claims benefit to German Patent Application No. DE 10 2024 122 345.6, filed on Aug. 6, 2024, which is hereby incorporated by reference herein.

### FIELD

The present disclosure relates to a method and a control system for operating a self-driving vehicle.

### BACKGROUND

It is known from the state of the art that self-driving vehicles can navigate automatically along a predetermined route. In order to check whether the vehicle is following the predetermined route, it is also known to evaluate a position or pose of the vehicle in relation to the route. The position or pose can be determined in absolute or relative terms in relation to the route or a road boundary. If the vehicle exceeds a safety limit value predefined for the position or pose, it is also known to put the vehicle in a safe operating state in order to avoid leaving the predetermined route in a safety-relevant manner.

From DE 10 2014 219 936 A1, a method for determining a control profile for a motor vehicle is known. In the method, a control profile is predefined for planning a motion path along which the motor vehicle is to be moved automatically, depending on a limit of a motor vehicle steering actuator. The limit predefined in this way can be based on maximum positions of the steering.

From DE 10 2021 115 265 A1 a method is known for lateral control of a vehicle in which a yaw rate controller detects a deviation of an actual yaw rate from a target yaw rate when the vehicle is moving. Based on the detected deviation, controller limits are shifted depending on a stable disturbance variable, so that the yaw rate with the stable disturbance variable represents a journey without a necessary controller intervention by the yaw rate controller.

### SUMMARY

In an embodiment, the present disclosure provides a method for operating a self-driving vehicle. The method includes specifying a lateral dynamics requirement for controlling a lateral dynamics of the self-driving vehicle along a predetermined route. The specified lateral dynamics requirement is communicated to a steering control device for controlling a steering kinematics of the self-driving vehicle based on the specified lateral dynamics requirement. The method checks whether the communicated lateral dynamics requirement fulfills a lateral dynamics criterion for the operation of the self-driving vehicle, and communicates a brake command to stop the self-driving vehicle based on a checking result.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a control system for operating a self-driving vehicle and such a system, according to the embodiments of the present disclosure; and

FIG. 2 shows a flow diagram with steps of a method for operating the self-driving vehicle, according to the embodiments of the present disclosure.

### DETAILED DESCRIPTION

One aspect concerns a method for operating a self-driving vehicle. The self-driving vehicle can be a vehicle that can drive without the influence of a human driver and can control the longitudinal and lateral dynamics of the vehicle itself without such influence. The self-driving vehicle can therefore be an autonomous vehicle. The self-driving vehicle can be operated in at least one degree of automation, which can be an assisted operating mode, an automated operating mode, or an autonomous operating mode.

The method has a step of specifying a lateral dynamics requirement to control the lateral dynamics of the self-driving vehicle along a predetermined route. According to one embodiment of the method, the specified lateral dynamics requirement can be or comprise a steering angle specification for controlling steering kinematics. The steering angle specification can comprise one of a steering angle, steering angle gradient, or steering angle jerk requested by a navigation device that the vehicle may have to control the lateral dynamics along the predetermined route. The requested steering angle gradient can be the first temporal or spatial derivative of the requested steering angle. The requested steering angle jerk may be the second temporal or spatial derivative of the requested steering angle. The predetermined route can be predetermined before or during the operation of the self-driving vehicle, where the predetermined route can be a statically or dynamically predetermined route.

The navigation device can be set up for lane guidance of the self-driving vehicle. Lane guidance can be lateral dynamic driving of the self-driving vehicle along the predetermined route. The lateral dynamics requirement can be an incorrect requirement, such as an incorrect steering angle specification, which causes the self-driving vehicle to leave the predetermined route. Therefore, safe guidance along the predetermined route cannot be provided based on the lateral dynamics requirement. The method makes it possible for safe lane guidance to continue to be controlled or regulated by early detection of the incorrect requirement. The method also makes it possible to efficiently achieve a safe operating condition through the early detection of the incorrect requirement.

Alternatively or in addition to the steering angle specification, the lateral dynamics requirement can be or comprise a yaw angle specification to control the steering kinematics of the self-driving vehicle. The yaw angle specification can comprise a yaw angle or yaw rate requested by the navigation device to control the lateral dynamics along the predetermined route. Furthermore, as an alternative or in addition to the steering angle specification, the lateral dynamics requirement can be or comprise a lateral dynamic route specification to control the steering kinematics of the self-driving vehicle. The lateral dynamic route specification can comprise a radius of a trajectory requested by the navigation device or a requested curvature of the trajectory along the route. Furthermore, as an alternative or in addition to the steering angle specification, the lateral dynamics requirement can be or comprise a lateral acceleration specification to control the steering kinematics of the self-driving vehicle. The lateral acceleration specification may comprise lateral acceleration of the vehicle requested by the navigation device.

According to one embodiment, the lateral dynamics requirement is filtered in time or place in the definition step. The method can thus have a temporal or spatial filtering of the lateral dynamics requirement as a further step. The lateral dynamics requirement can thus be advantageously provided for the further steps of the method in a robust manner.

As a further step, the method comprises communicating the specified lateral dynamics requirement to a steering control device to control steering kinematics of the self-driving vehicle based on the defined lateral dynamics requirement. The steering device may be set up separately from the navigation device, wherein the steering control device and the navigation device may be connected to each other wirelessly or by wire. The steering control device can therefore be a separate device from the navigation device. The steering control system may also be set up separately from the steering kinematics.

In the communication step, the lateral dynamics requirement can be communicated from the navigation device to the steering control device. If the steering control device is set up separately from the steering kinematics, the lateral dynamics requirement can be communicated to the steering control device via the steering kinematics, wherein the lateral dynamics requirement can also be a lateral dynamics requirement picked up or implemented by the steering control device at the steering kinematics. In the communication step, a lateral dynamics request can be communicated to the steering kinematics as a control parameter in order to control the vehicle along the predetermined route. The control parameter can comprise at least one of the requested steering angle, the requested steering angle gradient, the requested steering angle jerk, the requested yaw angle, the requested yaw rate, the requested radius, the requested curvature, and the requested lateral acceleration.

As a further step, the method involves checking whether the communicated lateral dynamics requirement fulfills a lateral dynamics criterion for the operation of the self-driving vehicle. The lateral dynamics criterion can be a predetermined lateral dynamics criterion. The lateral dynamics criterion can comprise a steering angle limit value to limit the steering kinematics or the lateral dynamics of the self-driving vehicle. The steering angle limit value can be a limit value for a steering angle, a steering angle gradient, or a steering angle jerk. In the checking step, it can be checked whether the communicated lateral dynamics requirement exceeds the steering angle limit value.

Alternatively or in addition to the steering angle limit value, the lateral dynamics criterion can comprise a yaw angle limit value to limit the steering kinematics or lateral dynamics of the self-driving vehicle. The yaw angle limit value can be a limit value for a yaw angle or for a yaw rate. In the checking step, it can thus be checked whether the communicated lateral dynamics requirement exceeds the yaw angle limit value. Furthermore, as an alternative or in addition to the steering angle limit value, the lateral dynamics criterion may comprise a route geometry limit value to limit the steering kinematics or lateral dynamics of the self-driving vehicle. The route geometry limit value can be a limit value for a radius or curvature of a trajectory to be traversed. In the checking step, it can thus be checked whether the communicated lateral dynamics requirement exceeds the route geometry limit value. Furthermore, as an alternative or in addition to the steering angle limit value, the lateral dynamics criterion may comprise a lateral acceleration limit value to limit the steering kinematics or lateral dynamics of the self-driving vehicle. In the checking step, it can thus be checked whether the communicated lateral dynamics requirement exceeds the lateral acceleration limit value.

According to another embodiment, the lateral dynamics criterion can be predetermined in such a way that the lane guidance of the self-driving vehicle can be regulated with the lateral dynamics requirement within the safety limit values of control technology. The lateral dynamics requirement can therefore be a control requirement for regulating the lane guidance. The lateral dynamics requirement can thus also be defined for controlling the lateral dynamics. With the method, such a control can be robustly permitted with the lateral dynamics criterion within the control technology safety limit values.

The method can be used in the checking step to check the lateral dynamics requirement specified by the navigation device and output by the navigation device to the steering controller based on the lateral dynamics criterion. The lateral dynamics criterion is a criterion that describes the lateral dynamics of the vehicle. The lateral dynamics criterion can therefore be a criterion describing the lateral dynamics of the vehicle and therefore not an internal steering criterion of a steering actuator. The method can be carried out independently of a lateral dynamics requirement set or implemented with the steering kinematics.

The method has as one step the communication of a brake command to stop the self-driving vehicle depending on a checking result resulting from the checking step. The checking result may be that the lateral dynamics requirement fulfils the lateral dynamics criterion. The checking result may be that the steering angle specification exceeds the steering angle limit value. Alternatively or in addition to this, the checking result may be that the yaw angle specification exceeds the yaw angle limit value. Further alternatively or additionally, the checking result may be that the lateral dynamic route specification exceeds the route geometry limit value. Further alternatively or additionally, the checking result may be that the lateral acceleration specification exceeds the lateral acceleration limit value.

The brake command can be issued to a brake device of the self-driving vehicle. The brake command can be communicated to induce emergency braking by the brake device. Stopping can be a safety braking maneuver, such as a standardized braking maneuver (a minimal risk maneuver or MRM). The braking maneuver can be performed to completely decelerate the self-driving vehicle. Stopping can bring the self-driving vehicle to a standstill with emergency braking without active lateral control.

The method can be used to react directly to the specified or output lateral dynamics requirement with the communicated brake command to bring the self-driving vehicle to a safe standstill before the lateral dynamics requirement can lead to an incorrect relative or absolute deviation in the location of the self-driving vehicle from the predetermined route. By checking the lateral dynamics requirement, an incorrect requirement can be detected at an early stage if the incorrect relative or absolute deviation in the location of the self-driving vehicle from the predetermined route that will result from the incorrect requirement in the future has not yet been reached. Extreme lateral dynamic corrections, such as steering corrections, which may be necessary to correct the location of the self-driving vehicle in the future, can thus be avoided. In addition, leaving a safety corridor by braking away from the predetermined route can be avoided. Furthermore, the method can be used to react in an advantageous way at an early stage to an incorrect lateral dynamics requirement. Thus the control technology reaction scope for regulating the lateral dynamic lane guidance can be advantageously maintained or increased. In addition, a safety corridor for lane guidance along the predetermined route can be reduced in size while maintaining robust control. In addition, a speed can be advantageously maintained or a reduction in speed in order to limit a braking distance during emergency braking can be advantageously avoided.

The communication of the brake command can be carried out to prevent the self-driving vehicle from leaving a predetermined drivable driving area along the route. To drive in the drivable driving area, the self-driving vehicle can be set up to detect deviations from the predetermined route and to adjust the current movement to the predetermined route. The drivable area can be a predetermined corridor containing the route. The corridor can extend laterally relative to the route. The drivable area may comprise a carriageway along the predetermined route. In addition to the roadway, the drivable area may have a run-off area for braking the self-driving vehicle. Stopping can bring the self-driving vehicle to a standstill with active lateral guidance within the drivable area.

According to another embodiment of the method, the steps of setting the lateral dynamics requirement and communicating the specified lateral dynamics requirement can be carried out by a navigation device arranged on the self-driving vehicle. The navigation device can be set up for automated navigation of the self-driving vehicle. The method can thus be advantageously carried out autonomously on the self-driving vehicle.

According to another embodiment of the method, it can be checked in the checking step whether a limit value for a lateral dynamic state of the self-driving vehicle is exceeded with the communicated lateral dynamics requirement. The limit value can be the steering angle limit value. Alternatively or additionally, the limit value can be the yaw angle limit value, the route geometry limit value, or the lateral acceleration limit value.

According to another embodiment of the method, the limit value for the lateral dynamic state can comprise at least one of a maximum steering angle, a maximum steering angle gradient and a maximum steering angle jerk. According to these embodiments, the brake command can be communicated in the communication step if the limit value is exceeded as a checking result resulting from the checking step. The self-driving vehicle can thus be efficiently put into a safe operating state.

According to another embodiment of the method, it can have as a further step a determination of the lateral dynamics criterion depending on a longitudinal dynamic state of the self-driving vehicle. The lateral dynamics criterion can be determined depending on or based on a longitudinal dynamic parameter, such as longitudinal speed or longitudinal acceleration. The lateral dynamics criterion can thus be predetermined in terms of longitudinal dynamics.

According to another embodiment of the method, it may include as a further step the determination of the lateral dynamics criterion depending on the location of the self-driving vehicle in relation to the predetermined route. The location can be a relative location in relation to a trajectory of the route. The lateral dynamics criterion can be determined depending on a relative position or distance of the self-driving vehicle to the route. The lateral dynamics criterion or limit value may be increased if the self-driving vehicle is in the predetermined corridor with a smaller deviation around the route. The lateral dynamics criterion or limit value can be reduced if the self-driving vehicle is in the predetermined corridor with an increased deviation around the route. The lateral dynamics criterion can thus be adapted to a current deviation of the self-driving vehicle from the predetermined route.

According to another embodiment of the method, it can be checked in the checking step whether the communicated lateral dynamics requirement fulfills the predetermined lateral dynamics criterion for a predetermined period of time. The resulting checking result can only be available if the communicated lateral dynamics requirement fulfils the predetermined lateral dynamics criterion for the predetermined period of time. The method can be carried out robustly with such a filter.

According to another embodiment of the method, the steps of checking the lateral dynamics requirement and communicating the brake command can be carried out by the steering control device. The steering control device may be set up to automatically bring the self-driving vehicle to a standstill. The method can thus continue to be carried out autonomously on the self-driving vehicle in an advantageous way.

Another aspect concerns a control system for operating a self-driving vehicle. The control system may be set up to carry out the method according to the preceding aspect. According to one embodiment, the control system is set up to carry out the method automatically on the self-driving vehicle.

The control system has a navigation device that is set up to specify a lateral dynamics requirement to control the lateral dynamics of the self-driving vehicle along a predetermined route and to communicate the specified lateral dynamics requirement to a steering control device to control steering kinematics of the self-driving vehicle. The control system has a checking device that is set up to check whether the communicated lateral dynamics requirement fulfills a lateral dynamics criterion for the operation of the self-driving vehicle, and to issue a brake command to stop the self-driving vehicle if the communicated lateral dynamics requirement fulfills the lateral dynamics criterion for the operation of the self-driving vehicle.

Another aspect concerns a self-driving vehicle that has a control system in accordance with the previous aspect for the automated operation of the self-driving vehicle. According to one embodiment, the control system is arranged on the self-driving vehicle.

An embodiment or feature of an aspect may be the corresponding embodiment or the corresponding feature of another aspect. Thus, the control system or the self-driving vehicle can have any device that can perform at least one step of the method.

### DETAILED DESCRIPTION OF EMBODIMENTS

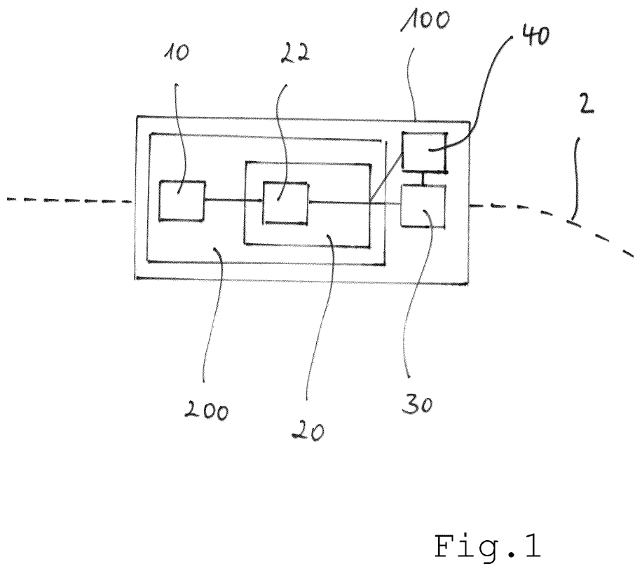

FIG. 1 shows a self-driving vehicle 100, which is operated along a predetermined route 2. The self-driving vehicle 100 has a navigation device 10, which is set up to specify a steering angle requirement for lateral dynamic control of the self-driving vehicle 100 along the predetermined route 2. The self-driving vehicle 100 also has a steering control device 20, which is set up to control steering kinematics 30 of the self-driving vehicle 100 based on the steering angle requirement. The navigation device 10 is connected to the steering control device 20 for communicating the steering angle requirement from the navigation device 10 to the steering control device 20. The self-driving vehicle 100 has a control system 200 for operating the self-driving vehicle 100. The control system 200 has the navigation device 10, the steering control device 20 and a checking device 22.

The steering control device 20 is set up to set a steering angle by means of the steering kinematics 30, which guides the self-driving vehicle 100 along the predetermined route 2 or, in the event of a deviation from it, leads back to it by control technology. The steering control device 20 is connected to the steering kinematics 30 to control or regulate a steering angle set by the steering kinematics 30. The steering control device 20 has a checking device 22, which is set up to check whether the steering angle requirement exceeds a steering angle limit value for limiting the steering kinematics 30. The checking device 22 is also set up to issue a brake command to stop the self-driving vehicle 100 to a brake device 40 of the self-driving vehicle 100 if the steering angle requirement exceeds the steering angle limit value. The brake device 40 is set up to bring about emergency braking of the self-driving vehicle 100 based on the brake command.

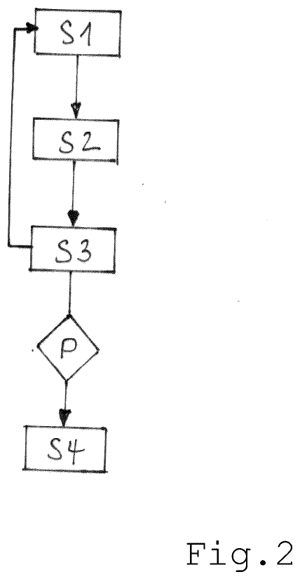

FIG. 2 shows a flow diagram with method steps S1 to S4 for operating the self-driving vehicle 100 along the predetermined route 2. In a first step S1, the steering angle requirement for controlling the steering kinematics 30 of the self-driving vehicle 100 along the predetermined route 2 is specified by the navigation device 10. In a second step S2, the specified steering angle requirement is communicated to the steering control device 20 for controlling the steering kinematics 30 of the self-driving vehicle 100.

In a third step S3, the steering control device 20 checks whether the communicated steering angle requirement exceeds the steering angle limit value, which is a safety-relevant lateral dynamics criterion for the lane guidance of the self-driving vehicle 100 along the predetermined route 2. If the steering angle requirement exceeds the steering angle limit value, the checking result P indicates that the safety-relevant lateral dynamics criterion is met. If the checking result P is not available, steps S1 to S3 are carried out repeatedly as a loop.

In a fourth step S4, the brake command is communicated by the steering control device 20 to the brake device 40 in order to bring about an emergency braking of the self-driving vehicle 100. The brake command is then communicated when the checking result P is available. The resulting emergency braking thus establishes a safe operating state of the self-driving vehicle 100 depending on the safety-relevant lateral dynamics criterion.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS (PART OF THE DESCRIPTION)

2 predetermined route
10 navigation device
20 steering control device
22 checking device
30 steering kinematics
40 brake device
100 self-driving vehicle
200 control system
P checking result
S1 specify lateral dynamics requirement
S2 communicate lateral dynamics requirement
S3 check lateral dynamics criterion
S4 communicate brake command

What is claimed is:

1. A method for operating a self-driving vehicle, comprising:
specifying a lateral dynamics requirement for controlling a lateral dynamics of the self-driving vehicle along a predetermined route;
communicating the specified lateral dynamics requirement to a steering control device for controlling a steering kinematics of the self-driving vehicle based on the specified lateral dynamics requirement;
checking whether the communicated lateral dynamics requirement fulfills a lateral dynamics criterion for the operation of the self-driving vehicle; and
communicating a brake command to stop the self-driving vehicle based on a checking result.

2. The method as claimed in claim 1, wherein the specified lateral dynamics requirement includes a steering angle specification for controlling the steering kinematics.

3. The method as claimed in claim 1, wherein the specifying the lateral dynamics requirement and communicating the specified lateral dynamics requirement are carried out by a navigation device arranged on the self-driving vehicle.

4. The method as claimed in claim 1, wherein the checking comprises determining whether a limit value for a lateral dynamics state of the self-driving vehicle is exceeded with the communicated lateral dynamics requirement, and wherein the brake command is communicated based on determining that the limit value is exceeded.

5. The method as claimed in claim 4, wherein the limit value for the lateral dynamic state comprises at least one of a maximum steering angle, a maximum steering angle gradient and a maximum steering angle jerk.

6. The method as claimed in claim 1, further comprising determining the lateral dynamics criterion depending on a longitudinal dynamic state of the self-driving vehicle.

7. The method as claimed in claim 1, further comprising determining the lateral dynamics criterion depending on a location of the self-driving vehicle in relation to the predetermined route.

8. The method as claimed in claim 1, wherein the checking comprises determining whether the communicated lateral dynamics requirement satisfies a predetermined lateral dynamics criterion for a predetermined period of time.

9. The method as claimed in claim 1, wherein checking the lateral dynamics requirement and communicating the brake command are carried out by the steering control device.

10. A control system for operating a self-driving vehicle, comprising:
a navigation device which is set up to specify a lateral dynamics requirement for controlling a lateral dynamics of the self-driving vehicle along a predetermined route and to communicate the specified lateral dynamics requirement to a steering control device for controlling steering kinematics of the self-driving vehicle; and
a checking device which is set up to check whether the communicated lateral dynamics requirement fulfills a lateral dynamics criterion for the operation of the self-driving vehicle and to issue a brake command to stop the self-driving vehicle if the communicated lateral dynamics requirement fulfills the lateral dynamics criterion for the operation of the self-driving vehicle.

11. A self-driving vehicle having the control system as claimed in claim 10 for an automated operation of the self-driving vehicle.
